(19) United States
(12) Patent Application Publication
(10) Pub. No.: US 2006/0167868 A1
(43) Pub. Date: Jul. 27, 2006

(54) Universal and extensible packaging process for computer system software integration and deployment

(76) Inventors: Weijia Zhang, Round Rock, TX (US); Kevin W. Deike, Round Rock, TX (US); Peter M. Giulietti, Elgin, TX (US); Charles T. Perusse JR., Pflugerville, TX (US)

Correspondence Address: HAMILTON & TERRILE, LLP, P.O. BOX 203518, AUSTIN, TX, 78720, US

(21) Appl. No.: 11/044,310

(22) Filed: Jan. 27, 2005

(51) Int. Cl. G06F 17/30

(52) U.S. Cl. 707/4

(57) ABSTRACT

A method and apparatus for automating the conversion of disparate software package delivery formats into a structured and universally acceptable software package format that uses metadata to describe its structure, contents, and related control information. The present invention facilitates the ability to support the direct input of software packages, including but not limited to BIOS, firmware, utility partitions, drivers and applications, for the integration and deployment of information handling systems. The method and apparatus of the present invention is extensible, enabling the support of multi-level license compliance and customized software installations. The extensibility provided by the present invention also enables a variety of other capabilities, including but not limited to, flexible support for fee-based distribution of software, expiration controls from internal and/or external control points, product lifecycle management, and product end-of-life controls.

### BACKGROUND OF THE INVENTION

1. Field of the Invention

The present invention relates in general to the field of information handling systems management and deployment, and more specifically, to automating the conversion of disparate software package delivery formats into a structured and universally acceptable software package format with inherently extensible capabilities.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, and how quickly and efficiently the information may be processed, stored, or communicated. The variations in information handling systems allow for information handling systems to be general or configured for a specific user or specific use, such as financial transaction processing, airline reservation, enterprise data storage, or global communications. In addition, information handling systems may include a variety of hardware and software components that may be configured to process, store, and communicate information, and may include one or more computer systems, data storage systems, and networking systems. Information handling systems continually improve in the ability of both hardware components and software applications to generate and manage information.

These improvements come at the cost of increased complexity as the possible combinations of system options, peripheral devices, and associated software applications grow at an exponential rate. A correspondingly large number of software components are required to initialize, integrate, configure and validate an information handling system platform and its related peripheral devices to a functional state. These software components, commonly delivered in the form of packages, are obtained from disparate sources in a variety of disparate formats.

The vast diversity and inconsistency of these formats introduces significant complexity into the integration of these software packages with information handling system platforms. Furthermore, many of these software packages are not usable in their native state, requiring tedious, manual, and time consuming intermediate steps to convert them into a state suitable for an information handling system manufacturing or support environment. Software vendors and users of information handling systems are equally challenged by these same issues, and possess a similar set of requirements.

Currently, no method exists for the automated and intelligent conversion of a variety of diverse and disparate software package delivery formats into a structured and universally acceptable software package format. This deficiency restricts the ability to support the direct input of software packages, including BIOS, firmware, utility partitions (e.g., a FAT32 disk partition containing a predetermined set of system diagnostic tools and utilities), drivers and applications. Further, existing software package formats are inherently nonextensible, impeding the support of multi-level license compliance and customized software installations. Likewise, fee-based distribution of software, expiration controls from internal and/or external control points, product lifecycle management, and product end-of-life controls are similarly restricted.

### SUMMARY OF THE INVENTION

The method and apparatus of the present invention overcomes the inadequacies of prior art by automating the conversion of disparate software package delivery formats into a structured and universally acceptable software package format that uses metadata to describe its structure, contents, and related control information. This structured universal software package format facilitates the ability to support the direct input of software packages, including but not limited to BIOS, firmware, utility partitions (e.g., a FAT32 disk partition containing a predetermined set of system diagnostic tools and utilities), and drivers and applications, for the integration and deployment of information handling systems.

Furthermore, as described in more detail hereinbelow, the present invention is extensible, enabling the support of multi-level license compliance and customized software installations. The extensibility provided by the present invention also enables a variety of other capabilities, including but not limited to, flexible support for fee-based distribution of software, expiration controls from internal and/or external control points, product lifecycle management, and product end-of-life controls.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a schematic diagram of a software installation system at an information handling system manufacturing site.

FIG. 2 is a generalized illustration of an information handling system, such as the target information handling system 120 illustrated in FIG. 1.

FIG. 3 is a general illustration of an extensible system for automating the conversion of disparate software package delivery formats into a structured and universally acceptable software package format that uses metadata to describe its structure, contents, and related control information.

FIG. 4 is a flowchart illustration of the processing sequence for implementing one embodiment of the inherent extensibility of the present invention where the content section of the metadata file contains executable files.

FIG. 5 is a flowchart illustration of the processing sequence for implementing one embodiment of the inherent extensibility of the present invention where the metadata file contains time-based control instructions relating to software expiry information.

FIG. 6 is a flowchart illustration of the processing sequence for implementing one embodiment of the inherent extensibility of the present invention where the metadata file contains run-per-machine control instructions.

FIG. 7 is a flowchart illustration of the processing sequence for implementing one embodiment of the inherent extensibility of the present invention where the metadata file contains compliance control instructions and parameters.

### DETAILED DESCRIPTION

Although the present invention has been described in detail, it should be understood that various changes, substitutions and alterations can be made hereto without departing from the spirit and scope of the invention as defined by the appended claims.

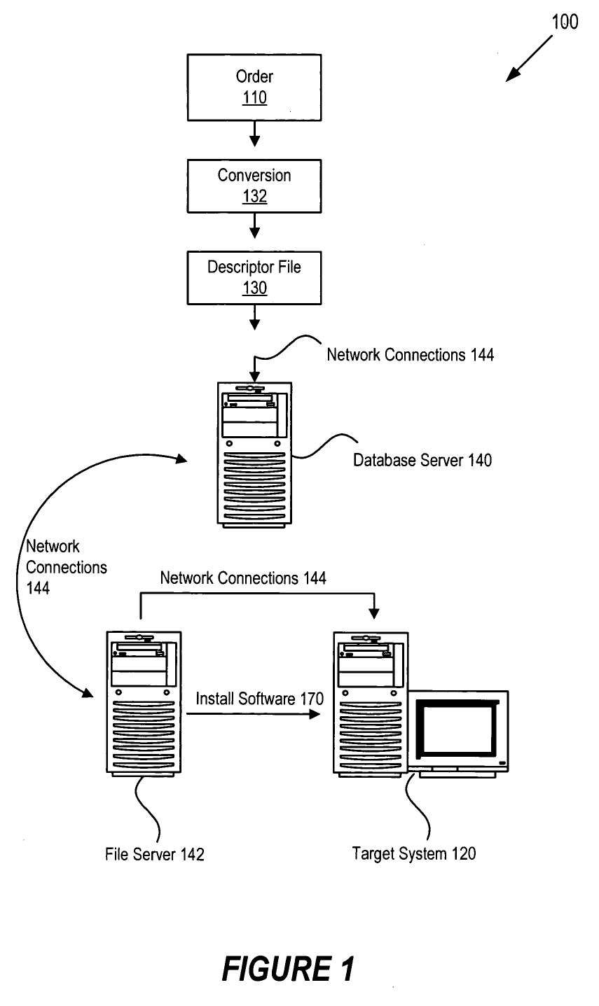

FIG. 1 is a schematic diagram of a software installation system 100 at an information handling system manufacturing site. In operation, an order 110 is placed to purchase a target information handling system 120. The target information handling system 120 to be manufactured contains a plurality of hardware and software components. For instance, target information handling system 120 might include a certain brand of hard drive, a particular type of monitor, a certain brand of processor and software. The software may include a particular version of an operating system along with all appropriate driver software and other application software along with appropriate software bug fixes. Before the target information handling system 120 is shipped to the customer, the plurality of components are installed and tested. Such software installation and testing advantageously ensures a reliable, working information handling system which is ready to operate when received by a customer.

Because different families of information handling systems and different individual computer components require different software installation, it is necessary to determine which software to install on a target information handling system 120. A descriptor file 130 is provided by converting an order 110, which corresponds to a desired information handling system having desired components, into a computer readable format via conversion module 132.

Component descriptors are computer readable descriptions of the components of target information handling systems 120, which components are defined by the order 110. In an embodiment of the present invention, the component descriptors are included in a descriptor file called a system descriptor record, which is a computer readable file containing a list of components, both hardware and software, to be installed onto target information handling system 120. Having read the plurality of component descriptors, database server 140 provides a plurality of software components corresponding to the component descriptors of file server 142 over network connection 144. Network connection 144 may be any network connection well-known in the art, such as a local area network, an intranet or the Internet. The information contained in database server 140 is often updated such that the database contains a new factory build environment. The software is then installed on the target information handling system 120. Upon completion, the information handling system 120 will have a predetermined set of software, including a predetermined set of drivers corresponding to the specific configuration of the information handling system 120.

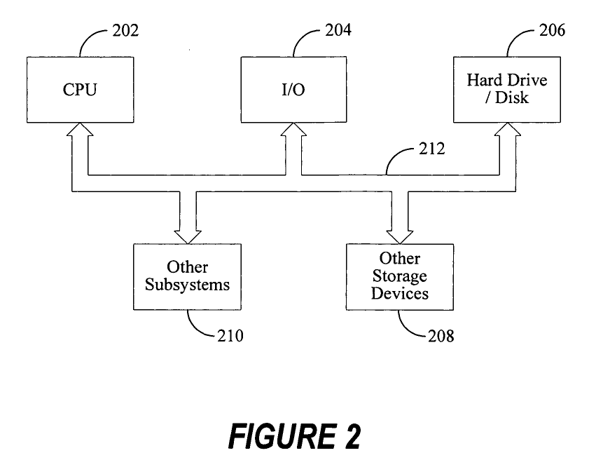

FIG. 2 is a generalized illustration of an information handling system, such as the target information handling system 120 illustrated in FIG. 1. The information handling system includes a processor 202, input/output (I/O) devices 204, such as a display, a keyboard, a mouse, and associated controllers, a hard disk drive 206, and other storage devices 208, such as a floppy disk and drive and other memory devices, and various other subsystems 210, all interconnected via one or more buses 212. The software that is installed according to the versioning methodology is installed onto hard disk drive 206. Alternatively, the software may be installed onto any appropriate non-volatile memory. The non-volatile memory may also store the information relating to which factory build environment was used to install the software.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

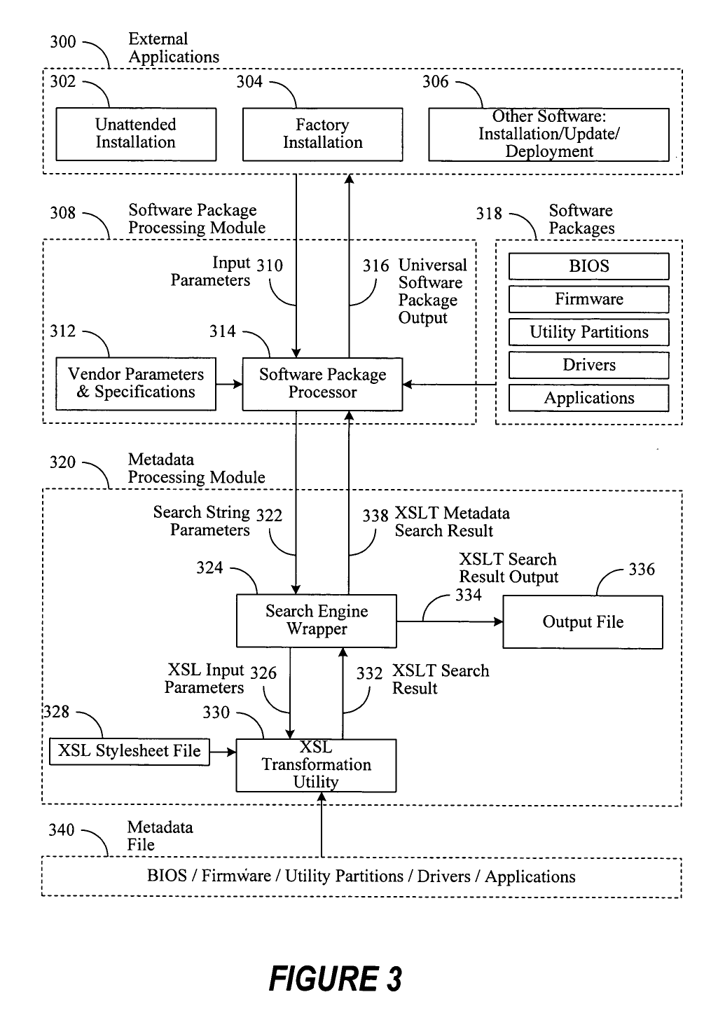

FIG. 3 is a general illustration of an extensible system for automating the conversion of disparate software package delivery formats into a structured and universally acceptable software package format that uses metadata to describe its structure, contents, and related control information. Those skilled in the art will recognize that the present invention is not limited to existing software package format conversions, but is equally proficient in the assembly of discrete software components into new software packages whose native format is structured, universally acceptable, and extensible.

In the system illustrated in FIG. 3, external applications 300 consisting of a predetermined selection of software installation, update or deployment applications, receive software packages in a structured and universally acceptable format, which are derived from software packages 318 in their native, nonstandard format, by a software package processing module 308, that interacts with a metadata processing module 320 which transforms existing metadata files 340.

Software packages delivered in a structured and universally acceptable format can be directly integrated into a plurality of information handling system platforms by external applications 300, whether through an unattended end-user installation 302, an automated factory installation 304, or other software installations, updates or deployments 306, such as by a software vendor or a user of an information handling system. Those familiar with the art will understand that information handling systems increasingly rely on frequent software changes and/or modifications, and these changes and their associated processes may take many forms, not all of which are represented by the external applications 300 illustrated in FIG. 3.

In general, a software package processing module 308 of the present invention receives input parameters 310 from external applications 300 that are used to install, update or deploy software packages.

In one embodiment of the invention, input parameters 310 from external applications 300 are in the form of queries that include information including, but not limited to, requested software package ID and information handling system platform information.

The queries are received by a software package processor 314 which combines them with vendor parameters and specifications 312. In one embodiment of the invention, vendor parameters and specifications 312 are provided by the information handling system manufacturer, which may incorporate parameters and specification provided by system component and/or peripheral device manufacturers. In another embodiment, vendor parameters and specifications 312 are provided by one or more software vendors. In other embodiments, the vendor parameters and specifications 312 may relate to a broad variety of hardware, firmware, software and/or business control information provided by a plurality of internal and external stakeholders involved in the integration of an information handling system.

The software package processor 314 constructs a search string 322 from the submitted queries and combined vendor parameters and specifications, which is received by a metadata processing module 320. Elements of the submitted search string 322 are inserted into a search string wrapper 324.

In one embodiment of the invention, the search engine wrapper 324 encapsulates XSL (extensible stylesheet language) input parameters 326, which are received by an XSL transformation utility 330. Those knowledgeable in the art will be familiar with the XSL specification, which consists of the XSL Transformations (XSLT) language for transformation, and Formatting Objects (FO), a vocabulary for describing the layout of documents. In this embodiment of the present invention, the XSL transformation utility 330 reads an XSL stylesheet file 328, consisting of one or more templates, which can include literal text that is used in the resulting transform, interspersed with directives to include specific data.

In one embodiment of the invention, the XSL stylesheet file 328 contains a single template, predefined for a specific combination of information handling system hardware and software. In another embodiment of the invention, the XSL stylesheet 328 contains one or more templates, predefined for a plurality of information handling system hardware and software combinations. In other embodiments of the invention, the XSL stylesheet 328 contains a plurality of templates that can be read and combined as needed by the XSL transformation utility 330 for a plurality of information handling system hardware and software combinations.

Once templates from the XSL stylesheet file 328 are read by the XSL transformation utility 330, one or more metadata files 340 are searched for desired software and/or related information. Those skilled in the art are aware that XSLT uses the XML Path Language (XPath), a separate specification that describes a means of defining simple queries. In one embodiment of the invention, the XSL transformation utility 330 uses XPath to create simple queries based on directives and instructions present within the templates contained by an XSL stylesheet file 328. In this embodiment, XPath queries are used to search metadata files 340 for software files and related information including, but not limited to, executable files, file parameters, and file locations.

In one embodiment of the present invention, XSLT search results 332 are returned to the search engine wrapper 324, including executable files. In another embodiment of the invention, only software file parameters and locations are returned. In other embodiments, a variety of executable files, file parameters, file locations, and related control information are returned. In one embodiment of the invention, XSLT search results 332 are received by the search engine wrapper 324 and routed as XSLT search result output 334 to be stored as an output file 336 for later use. In another embodiment of the invention, XSLT search results 332 are received by the search engine wrapper 324 and routed as XSLT metadata results 338 to the software package processor 314.

The software package processor 314 constructs a software delivery package in a structured and universally accepted format 316, which is routed to external applications 300 that are used to install, update or deploy software packages.

In one embodiment of the invention, the XSLT metadata search result 338 contains all software executable files, file parameters, and related control information required for the software package processor 314 to construct a software delivery package in a structured and universally accepted format 316. In another embodiment of the invention, the XSLT metadata search result 338 contains locations of software files to be retrieved from existing software packages 318, including but not limited to, BIOS, firmware, utility partitions (e.g., a FAT32 disk partition containing a predetermined set of system diagnostic tools and utilities), drivers and applications. The required files are retrieved from their specified locations within existing software packages 318 and combined with associated parameters and control information also contained in the associated XSLT metadata search result 338, and then processed by the software package processor 314 to construct a software delivery package in a structured and universally accepted format 316. In other embodiments of the invention, the XSLT metadata search result 338 contains a combination of software executable files and locations of files to be retrieved. The required files are retrieved from their specified locations within existing software packages 318 and combined with the executable files, associated file parameters and control information also contained in the associated XSLT metadata search result 338, and then processed by the software package processor 314 to construct a software delivery package in a structured and universally accepted format 316.

Those skilled in the art will recognize that each of the referenced components in these embodiments of the invention may be comprised of a plurality of components, each interacting with the other in a distributed environment. Furthermore, other embodiments of the invention may expand on the referenced embodiment to extend the scale and reach of the system's implementation.

The present invention, as discussed in greater detail hereinbelow, provides a method and apparatus that overcomes the shortcomings of prior art by automating the conversion of disparate software package delivery formats into a structured and universally acceptable software package format with inherently extensible capabilities. Further, all related details of the software package format conversion, and extensions thereof, are automatically recorded and stored by the present invention in a manner conducive to future retrieval, review, analysis, modification, and possible re-use. Those skilled in the art will recognize that such automation may be a composite of one or more individual instructions that can be combined in a variety of ways to accomplish different goals and/or to accommodate specific integration, implementation and/or deployment requirements. Furthermore, the instructions may be manually entered through a human interface, or may be entered automatically by one or more information handling systems, directly connected to the software package format conversion system or connecting through a network, with some instructions possibly invoking other individual or composite instructions as required.

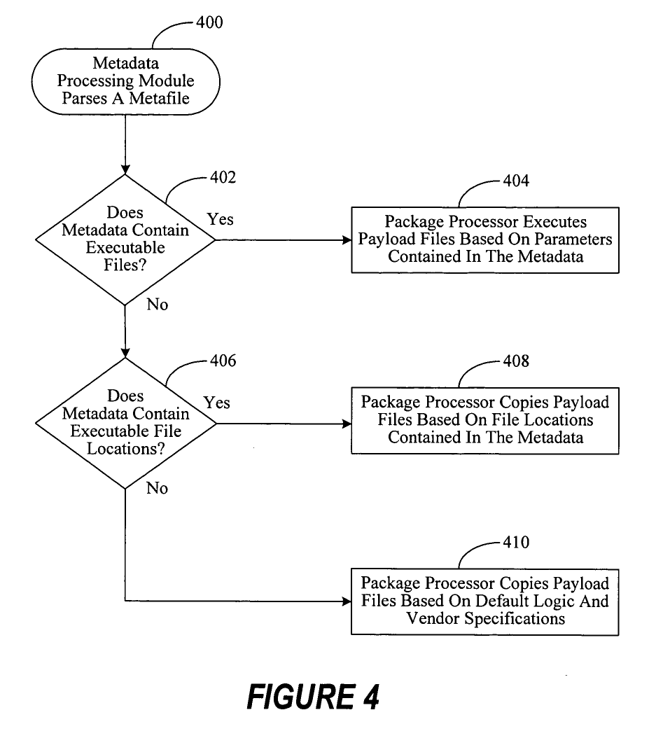

FIG. 4 is a flowchart illustration of the processing sequence for implementing one embodiment of the inherent extensibility of the present invention. In step 400, a metadata processing module parses a metadata file, and in step 402 examines the metadata to determine whether the content section of the metadata file contains executable files. If executable files are present, they are processed in step 404 by the software package processor according to control instructions and parameters included in the metadata file. If executable files are not present, the metadata is examined in step 406 to determine whether it contains the locations of executable files. If the executable file locations are present, the software package processor copies the executable files in step 408, from the locations contained in the metadata, and then processes them according to control instructions and parameters included in the metadata file. If the locations of executable files are not present, the software package processor copies executable files in step 410 using default logic and/or vendor specifications that are contained in the metadata. For example, the default logic present in the metadata file may instruct the metadata processing module to execute default or baseline executable files on the target information handling system platform if neither executable files nor their locations are present in the metadata file. Those skilled in the art will understand that other embodiments of the invention, including but not limited to combinations of, extensions to, and variations of, the steps described hereinabove are possible, which are by no means all inclusive as represented in FIG. 4.

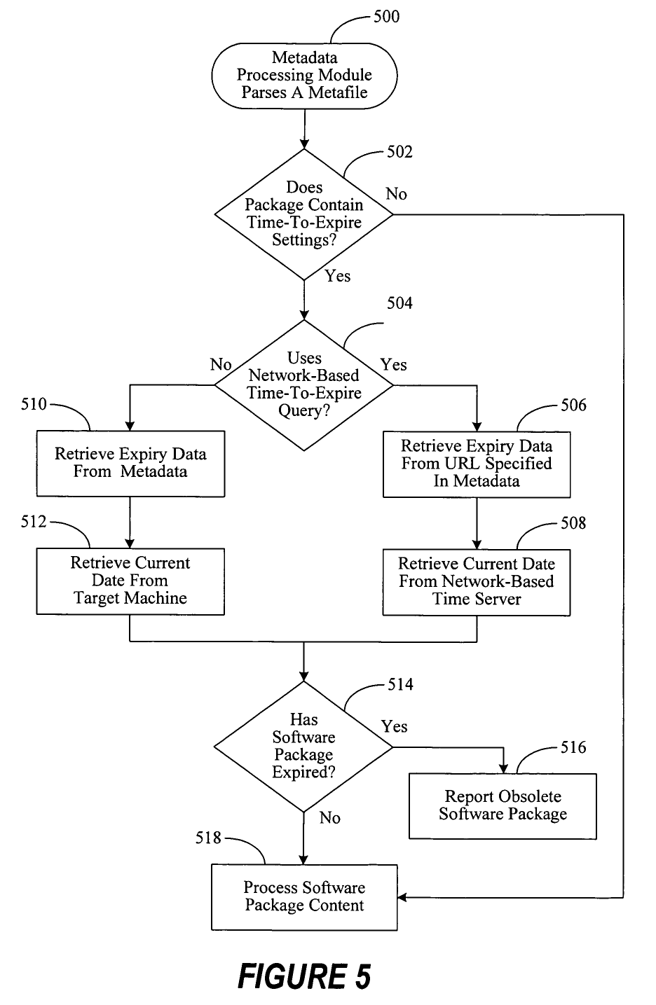

FIG. 5 is a flowchart illustration of the processing sequence for implementing one embodiment of the inherent extensibility of the present invention. In step 500, a metadata processing module parses a metadata file. In step 502, the metadata is examined to determine whether the metadata file contains time-based control instructions relating to software expiry information.

If the metadata file does not contain time-based control instructions relating to software expiry information, then in step 518, the software package contents are processed.

In step 504, the metadata is examined to determine whether the time-based software expiry control instructions are network-based.

In step 506, software expiry information is retrieved from the URL specified in the metadata if the time-based software expiry control instructions are network-based. In step 508, the current time and date is retrieved from a network-based time server. In one embodiment of the invention, the time server is owned and operated by the information handling system platform manufacturer. In another embodiment of the invention, the time server is owned and operated by the software vendor. In another embodiment of the invention, the time server is Internet-based, and may or may not be authenticated as accurate. In other embodiments of the invention a combination of time servers, public or privately-owned, may be included in the metadata along with control logic specifying which, if any, of the time servers are accessed and under what conditions. In step 514, the current time and date information retrieved from a network-based time server is compared to the software expiry information contained in the metadata. If the software expiry information contained in the metadata is expired, the software package is reported to be in an obsolete state.

In step 510 software expiry information is retrieved from the metadata if time-based software expiry control instructions are not network-based. In step 512, the current time and date are retrieved from the target information handling system platform. In step 514, the current time and date information retrieved from the target information handling system platform is compared to the software expiry information contained in the metadata. If the software expiry information contained in the metadata is expired, the software package is reported to be in an obsolete state.

In one embodiment of the invention, the obsolete state of the software package may denote that the software license has expired. In another embodiment of the invention, the obsolete state of the software package may denote that a newer version of the software package, or one of its components, is required. In another embodiment of the invention, the obsolete state of the software package may denote that the software package, or one of its components, is incompatible with the target information handling system platform or one of its components. Those knowledgeable in the art will appreciate that other embodiments of the invention including but not limited to combinations of, extensions to, and variations of, the steps described hereinabove are possible, including the possible uses of time-based software expiry information, which are by no means all inclusive as represented in FIG. 5.

In step 514, software expiry information contained in the metadata is compared to the current time and date information retrieved from the target information handling system platform, or from a network-based time server. If the software expiry information contained in the metadata has not expired, then in step 518, the software package contents are processed.

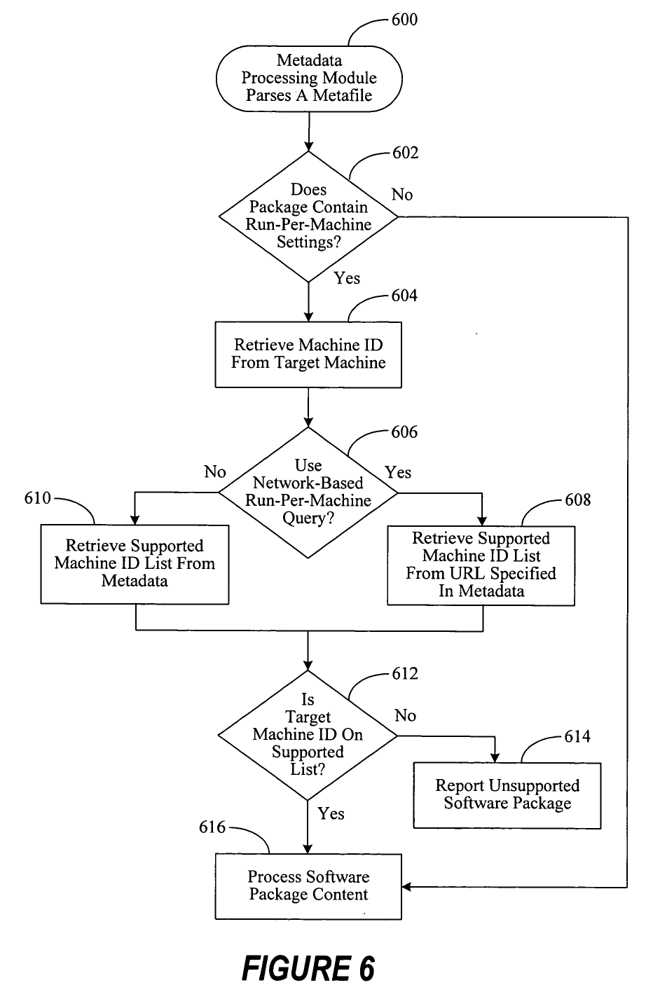

FIG. 6 is a flowchart illustration of the processing sequence for implementing one embodiment of the inherent extensibility of the present invention. In step 600, a metadata processing module parses a metadata file. In step 602, the metadata is examined to determine whether the metadata file contains run-per-machine control instructions.

If the metadata file does not contain run-per-machine control instructions, then step 616 processes the software package contents.

In step 604, the machine ID is retrieved from the target information handling system platform.

In step 606, the metadata is examined to determine whether the run-per-machine control instructions are network-based.

In step 608, a supported machine ID list is retrieved from the URL specified in the metadata if the run-per-machine control instructions are network-based. In one embodiment of the invention, the supported machine ID list is owned and/or maintained by the information handling system platform manufacturer. In another embodiment of the invention, the supported machine ID list is owned and/or maintained by the software vendor. In other embodiments of the invention a combination of supported machine ID list, owned and/or maintained by a plurality of stakeholders, may be included in the metadata along with control logic specifying which, if any, of the supported machine ID lists are accessed and under what conditions. In step 612, the network-based, supported machine ID list retrieved in step 608 is compared to the machine ID retrieved in step 604. If the machine ID retrieved in step 604 is not contained within the network-based, supported machine ID list retrieved in step 608, the software package is reported to be in an unsupported package in step 614.

In step 610, a supported machine ID list is retrieved from the metadata if run-per-machine control instructions are not network-based. In step 612, the supported machine ID list retrieved in step 610 is compared to the machine ID retrieved in step 604. If the machine ID retrieved in step 604 is not contained within the supported machine ID list retrieved from metadata in step 610, the software package is reported to be in an unsupported package in step 614.

In one embodiment of the invention, the unsupported state of the software package may denote that a newer version of the software package, or one of its components, is required. In another embodiment of the invention, the unsupported state of the software package may denote that the software package, or one of its components, is incompatible with the target information handling system platform or one of its components. Those knowledgeable in the art will appreciate that other embodiments of the invention including but not limited to combinations of, extensions to, and variations of, the steps described hereinabove are possible, including the possible uses of run-per-machine control information, which are by no means all inclusive as represented in FIG. 6.

In step 612, the machine ID retrieved in step 604 is compared to the network-based, supported machine ID list retrieved in step 610 and the supported machine ID list retrieved from metadata in 608. If the machine ID retrieved in step 604 is contained within either of the supported machine ID lists, then in step 616, the software package contents are processed.

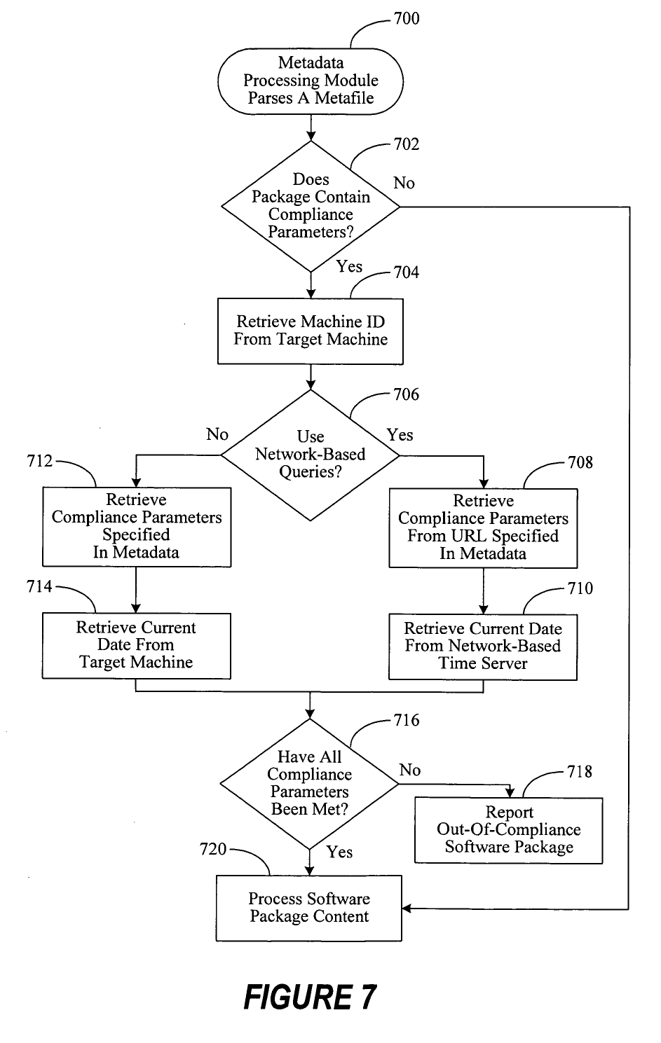

FIG. 7 is a flowchart illustration of the processing sequence for implementing one embodiment of the inherent extensibility of the present invention. In step 700, a metadata processing module parses a metadata file. In step 702, the metadata is examined to determine whether the metadata file contains compliance control instructions and parameters.

If the metadata file does not contain compliance control instructions and parameters, then in step 720, the software package contents are processed.

In step 704, the machine ID is retrieved from the target information handling system platform.

In step 706, the metadata is examined to determine whether the compliance control instructions and parameters are network-based.

In step 708, compliance control instructions and parameters are retrieved from the URL specified in the metadata if they are network-based. In one embodiment of the invention, the compliance control instructions and parameters are owned and/or maintained by the information handling system platform manufacturer. In another embodiment of the invention, the compliance control instructions and parameters are owned and/or maintained by the software vendor. In other embodiments of the invention a combination of compliance control instructions and parameters, owned and/or maintained by a plurality of stakeholders, may be included in the metadata along with control logic specifying which, if any, compliance control instructions and parameters are accessed and under what conditions.

In step 710, the current time and date is retrieved from a network-based time server. In one embodiment of the invention, the time server is owned and operated by the information handling system platform manufacturer. In another embodiment of the invention, the time server is owned and operated by the software vendor. In another embodiment of the invention, the time server is Internet-based, and may or may not be authenticated as accurate. In other embodiments of the invention a combination of time servers, public or privately-owned, may be included in the metadata along with control logic specifying which, if any, of the time servers are accessed and under what conditions.

In step 716, the network-based, compliance control instructions and parameters retrieved in step 708 are compared to the machine ID retrieved in step 704 and the current time and date retrieved in step 710. If the machine ID retrieved in step 704, and the current time and date retrieved in step 710 fail to satisfy the network-based, compliance control instructions and parameters retrieved in step 708, the software package is reported to be out of compliance in step 718.

In step 712, compliance control instructions and parameters are retrieved from the metadata if they are not network-based. In step 714, the current time and date are retrieved from the target information handling system platform.

In step 716, compliance control instructions and parameters retrieved from the metadata in step 712 are compared to the machine ID retrieved in step 704 and the current time and date retrieved in step 714. If the machine ID retrieved in step 704, and the current time and date retrieved in step 714 fail to satisfy the compliance control instructions and parameters retrieved from metadata in step 712, the software package is reported to be out of compliance in step 718.

In one embodiment of the invention, the out-of-compliance state of the software package may denote that a newer version of the software package, or one of its components, is required to maintain proper interaction and/or functionality with other information handling systems. In another embodiment of the invention, the out-of-compliance state of the software package may denote that the software package, or one of its components, is out of compliance with the current software license agreement associated with the information handling system owner. In another embodiment of the invention, the out-of-compliance state of the software package may denote that the software package, or one of its components, is out of compliance with the financial, governance and/or oversight controls required by certain regulatory agencies. Those knowledgeable in the art will appreciate that other embodiments of the invention including but not limited to combinations of, extensions to, and variations of, the steps described hereinabove are possible, including the possible uses of compliance control information, which are by no means all inclusive as represented in FIG. 7.

In step 716, the machine ID retrieved in step 704 is compared to the network-based, compliance control instructions and parameters retrieved in step 708 and/or the compliance control instructions and parameters retrieved from metadata in step 712, along with the network-based, current time and date retrieved in step 710 and/or the current time and date retrieved from the target machine in step 714. If the machine ID retrieved in step 704, and the current time and date retrieved in step 710 or step 714 satisfy the compliance control instructions and parameters retrieved in step 708 or step 712, then in step 720, the software package contents are processed.

Use of the invention will insure, at a minimum, that disparate software package delivery formats can automatically be converted into a structured and universally acceptable software package format with inherently extensible capabilities providing unified metadata support for BIOS, firmware, utility partitions (e.g., a FAT32 disk partition containing a predetermined set of system diagnostic tools and utilities), driver, application software integration, implementation and deployment. Further, full separation of metadata and payload within the structured and universally acceptable software package format allows metadata to be digitally signed for secure and auditable processing. In addition, the present invention supports multiple levels of compliance, software package expiration controls, and reduced proliferation of software packages containing essentially the same components causing conflict during installation.

What is claimed is:

1. A system for software integration and deployment for an information handling system, comprising:
a package processor operable to receive a query from an installation program and to provide an output package for said installation program in response to said query;
a metadata file processor operable to receive a search request from said package processor and to generate a metadata search result for said package processor in response to said search request; and
wherein said output package provided by said package processor comprises metadata in a universal and extensible format.

2. The system of claim 1, wherein said query from said installation program comprises package identifier information and system information and wherein said package processor is operable to convert said query into a search string that is submitted to said metadata file processor.

3. The system of claim 2, wherein said metadata processor comprises a search engine operable to execute a structured query language transformation utility thereby generating transformed metadata search results in response to said search requests.

4. The system of claim 3, wherein said metadata processor provides information corresponding to file parameters and file locations in response to said search request.

5. The system of claim 4, wherein said metadata processor is operable to detect executable files corresponding to said search request.

6. The system of claim 5, wherein said metadata processor is operable to support multiple levels of compliance.

7. The system of claim 6, wherein said metadata processor is operable to execute a time-to-expire algorithm.

8. The system of claim 6, wherein said metadata processor is operable to execute a run-per-machine algorithm.

9. The system of claim 1, wherein the output package provided by said package processor comprises separated metadata and payload.

10. The system of claim 1, wherein said metadata corresponding to said output package is digitally signed.

11. A method for software integration and deployment for an information handling system, comprising:
generating a query from an installation program;
providing said query to a package processor, said package processor being operable to provide an output package for said installation program in response to said query;
generating a search request from said package processor in response to said query;
providing said search request to a metadata file processor, said metafile processor being operable to generate a metadata search result for said package processor in response to said search request; and
wherein said output package provided by said package processor comprises metadata in a universal and extensible format.

12. The method of claim 11, wherein said query from said installation program comprises package identifier information and system information and wherein said package processor is operable to convert said query into a search string that is submitted to said metadata file processor.

13. The method of claim 12, wherein said metadata processor comprises a search engine operable to execute a structured query language transformation utility thereby generating transformed metadata search results in response to said search requests.

14. The method of claim 13, wherein said metadata processor provides information corresponding to file parameters and file locations in response to said search request.

15. The method of claim 14, wherein said metadata processor is operable to detect executable files corresponding to said search request.

16. The method of claim 15, wherein said metadata processor is operable to support multiple levels of compliance.

17. The method of claim 16, wherein said metadata processor is operable to execute a time-to-expire algorithm.

18. The method of claim 16, wherein said metadata processor is operable to execute a run-per-machine algorithm.

19. The method of claim 11, wherein the output package provided by said package processor comprises separated metadata and payload.

20. The method of claim 11, wherein said metadata corresponding to said output package is digitally signed.
